(19) United States
(12) Patent Application Publication
(10) Pub. No.: US 2011/0017874 A1
(43) Pub. Date: Jan. 27, 2011

(54) Means of fuel and oxidizer storage

(75) Inventor: Richard Alan Haase, Missouri City, TX (US)

Correspondence Address: RICHARD A. HAASE (INVENTOR), 4402 RINGROSE DRIVE, MISSOURI CITY, TX, 77459, US

(73) Assignee: ClearValue Technologies, Inc., Missouri City, TX (US)

(21) Appl. No.: 12/924,494

(22) Filed: Sep. 28, 2010

Related U.S. Application Data
(63) Continuation-in-part of application No. 12/734,836.
(60) Provisional application No. 61/004,326, filed on Nov. 26, 2007.
(60) Provisional application No. 61/277,665, filed on Sep. 28, 2009.

(51) Int. Cl. B64G 1/66; F25J 1/02; F01K 13/00; B64G 1/42

(52) U.S. Cl. 244/172.2; 62/607; 60/645; 60/643

(57) ABSTRACT

The instant invention relates to improved means for the storage of H₂ and O₂, wherein the H₂ and/or the O₂ is stored on a vessel, ship or other non-Earth body in Space, whether manned or unmanned. Further, the instant invention relates to improved means for the storage of fuel, preferably hydrogen (H₂) and oxidizer, preferably oxygen (O₂), wherein the H₂ and O₂ are obtained from at least one storage tank or obtained by electrolysis of water (H₂O). The instant invention does not require a hydrocarbon fuel source. H₂O is the primary product of combustion; while in many embodiments of the instant invention, H₂O is separated into H₂ and O₂, thereby making H₂O an efficient method of storing fuel and oxidizer.

### RELATED APPLICATION DATA

This application claims priority on U.S. Provisional Application 61/277,665 filed Oct. 28, 2009; U.S. Non-provisional application Ser. No. 12/734,836 filed Nov. 26, 2008; PCT/US08/013,214 filed Nov. 25, 2008 and U.S. Provisional Application 61/004,326 filed Nov. 26, 2007.

### BACKGROUND OF THE INVENTION

### Field of the Invention

The instant invention relates to improved methods, systems, processes and apparatus for the storage of fuel, preferably hydrogen (H₂) and oxidizer, preferably oxygen (O₂), wherein the H₂ and O₂ are obtained from at least one storage tank or obtained by electrolysis of water (H₂O). The instant invention does not require a hydrocarbon fuel source. H₂O is the primary product of combustion; while in many embodiments of the instant invention, H₂O is separated into H₂ and O₂, thereby making H₂O an efficient method of storing fuel and oxidizer.

The instant invention relates to improved methods, systems, processes and apparatus for the storage of H₂ and O₂, wherein the H₂ and/or the O₂ is stored on a vessel, ship or other Non-Earth Body in Space, whether manned or unmanned. (Herein after instant invention improved methods, systems, processes and apparatus for the storage of H₂ and O₂, wherein the H₂ and/or O₂ is stored on a vessel, ship or other Non-Earth Body in Space is termed Space F&O Means. Space herein is defined as any location in height above the Earth's Surface which is greater than about 30,000 feet. Space Ship or Vessel is herein defined as any man-made device or apparatus travelling at an altitude of about greater than about 30,000 feet.) Non-earth Body is herein defined as any object in Space which orbits another object of greater mass.

Space F&O Means significantly improve said storage efficacy, thereby reducing the amount of H₂ and/or O₂ required in storage, and thereby significantly reducing the weight of H₂ and/or O₂ required in storage, while thereby significantly increasing payload capability of a Space vessel or ship.

The instant invention relates to improved methods, systems, processes and apparatus for producing torque from the combustion of H₂ and O₂.

Space F&O Means comprises improved combustion thermodynamics, thereby significantly improving the power and efficiency of combustion. Space F&O Means incorporates embodiments wherein steam produced by combustion: 1) maintains the power output of combustion, 2) provides method(s) of energy transfer, 3) provides an efficient method of energy recycle, 4) provides power through steam, and 5) cools the combustion chamber. Steam presents a potential (reusable) energy source, both from the available kinetic and the available heat energy, as well as the conversion of the steam into H₂ and O₂.

Space F&O Means relate to generating electricity (electrical energy). Two means of generating electricity are discovered. The first places a steam turbine in the exhaust of a combustion engine of the instant invention, wherein said steam turbine is driven by steam produced in combustion, and wherein said steam turbine turns a generator (the term generator is defined herein to be either a generator, an alternator or a dynamo); and wherein at least a portion of said steam energy is converted into said electricity. The second places a generator to receive the mechanical rotating energy output of a combustion engine of the instant invention, wherein at least a portion of said mechanical rotating energy is converted by the generator into electricity.

Space F&O Means relates to combustion, wherein the thermodynamics of the Otto Cycle are improved providing improved combustion efficiency and power output.

Space F&O Means relates to combustion, wherein combustion comprises the thermodynamics of the Haase Cycle.

Space F&O Means relate to the combustion of H₂ with O₂, wherein said combustion powers a liquefaction unit for the storage of at least one of said H₂ and said O₂.

Space F&O Means relate to the management of heat energy from liquefaction, wherein said heat energy is rejected such that liquefaction of said H₂ and/or of said O₂ is efficacious.

Finally, Space F&O Means relate to applications of producing mechanical or electrical energy, as well as improved hydrogen and/or oxygen storage in applications at an altitude above the surface of the earth.

### Background of the Invention

Mankind ventured from home, Earth, beginning in the 1960's with Space Travel. By 1969, Neal Armstrong and Buzz Aldrin were walking on Earth's Moon. The Apollo Rocket which launched the Apollo Space Vessel (Capsule or Ship) was fueled by a liquid cryogenic fuel, H₂, and a liquid cryogenic oxidizer, O₂. While said H₂ and O₂ were the most efficient means of potential energy storage to power Apollo, Space Temperatures in Earth Orbit and/or orbiting Earth's Moon and/or in travel to/from Earth's Moon are significantly above the boiling point of H₂, which is about 20 K at 15 psia, and when in direct sunlight are often above the boiling point of O₂, which is about 90 K at 15 psia. Therefore, a Space Vessel powered by at least one of H₂ and O₂ will encounter fuel, H₂, and/or oxidizer, O₂, losses when the ambient, Space, temperature, such as that of when near Earth, near Earth's Moon or close enough to any star or close enough to any light reflective object. FIG. 2, presented by NASA at the 2007 Galveston Conference, reveals significant average H₂ losses during the Apollo Program.

Prior to this instant invention, previous work in the Water Combustion Technology (WCT) and the Haase Cycle for Space Travel is referenced herein in PCT/US08/13214.

Prior to this instant invention, previous work in the Water Combustion Technology (WCT) and the Haase Cycle is referenced herein in U.S. application Ser. No. 10/790,316, PCT/US 03/11250, PCT/US 03/41719 and PCT/US06/048057.

Previous work to develop a combustion engine prior to the WCT and the Haase Cycle that would operate on fuel(s) other than hydrocarbon(s) is referenced herein in U.S. Pat. No. 2,406,605; U.S. Pat. No. 3,459,953: U.S. Pat. No. 3,884,262, U.S. Pat. No. 3,939,806; U.S. Pat. No. 3,982,878, U.S. Pat. No. 4,167,919, U.S. Pat. No. 4,308,844; U.S. Pat. No. 4,440,545; U.S. Pat. No. 4,599,865; U.S. Pat. No. 4,841,731; U.S. Pat. No. 5,775,091, U.S. Pat. No. 5,293,857; U.S. Pat. No. 5,388,395; U.S. Pat. No. 5,782,081, U.S. Pat. No. 5,775,091; U.S. Pat. No. 5,899,072; U.S. Pat. No. 5,924,287; U.S. Pat. No. 6,212,876; U.S. Pat. No. 6,290,184; and U.S. Pat. No. 6,698,183. The closest work to this instant invention is U.S. Pat. No. 4,841,731 and U.S. Pat. No. 6,289,666 B 1. While each of these patents present improvements in combustion technology, each leaves issues that have left the commercialization of such a combustion engine impractical.

Combustion Engine Thermodynamics

Much has been much done mechanically and chemically to combat the environmental issues associated with hydrocarbon combustion. Often, industrial facilities are outfitted with expensive scrubber systems whenever the politics demand installation and/or the business supports installation. As another example, the internal combustion engine has been enhanced significantly to make the engine more fuel efficient and environmentally friendly. However, even with enhancement, absent the WCT, an internal combustion engine is only approximately 20 percent efficient and the gas turbine/steam turbine system is only approximately 20 to 40 percent efficient. The traditional internal combustion engine looses as a percentage of available energy fuel value: 1) approximately 35 percent in the exhaust, 2) approximately 35 percent in cooling, 3) approximately 9 percent in friction, and 4) approximately 3 percent due to combustion performance, leaving the engine approximately less than 20 percent efficient.

Liquefaction

Liquefaction incorporates cryogenic refrigeration, wherein there are many known methods of cryogenic refrigeration. A good reference of cryogenic refrigeration methods and processes known in the art, and referenced herein, would be “Cryogenic Engineering,” written by Thomas M. Flynn and printed by Dekker. As written by Flynn, “cryogenic refrigeration and liquefaction are the same processes, except liquefaction takes off a portion of the refrigerated liquid which must be made up, wherein refrigeration all of the liquid is recycled. All of the methods and processes of refrigeration and liquefaction are based upon the same basic refrigeration principals”, as depicted in FIG. 2.

As written by Flynn, there are many ways to combine the few components of work (compression), rejecting heat, expansion (Joule Thompson Effect) and absorbing heat. There exist in the art many methods and processes of cryogenic refrigeration, all of which can be adapted for cryogenic liquefaction. A listing of those refrigeration cycles include, yet are not limited to: Joule Thompson, Sterling, Brayton, Claude, Linde, Hampson, Postle, Ericsson, Gifford-McMahon and Vuilleumier. (Herein Joule Thompson Effect is defined as any means of expansion of a fluid wherein a cooling of the fluid is performed.) As written by Flynn, “There are as many ways to combine these few components as there are engineers to combine them.” (It is important to note, as is known in the art, that H₂ has a negative Joule-Thompson coefficient until temperatures of approximately 350 R or less are obtained.)

While it is well known in the chemical industry that the cryogenic distillation of air into O₂, N₂ and Ar₂; cryogenic distillation is the most economical pathway to produce these elemental diatomic gases. Previous work performed to separate air into its components is herein referenced in U.S. Pat. No. 4,112,875; U.S. Pat. No. 5,245,832; U.S. Pat. No. 5,976,273; U.S. Pat. No. 6,048,509; U.S. Pat. No. 6,082,136; U.S. Pat. No. 6,298,668 and U.S. Pat. No. 6,333,445.

Steam Conversion

The discovered instant invention relates to producing H₂ from steam, since steam is the physical state of the H₂O product from combustion. Previous work in this field has focused on refinery or power plant exhaust gases; none of that work discusses the separation of steam back into H₂. Previous work performed to utilize the products of hydrocarbon combustion from an internal combustion engine can be referenced in U.S. Pat. No. 4,003,343. Previous work in corrosion is in the direction of preventing corrosion instead of encouraging corrosion, yet is herein referenced in U.S. Pat. No. 6,315,876, U.S. Pat. No. 6,320,395, U.S. Pat. No. 6,331,243, U.S. Pat. No. 6,346,188, U.S. Pat. No. 6,348,143 and U.S. Pat. No. 6,358,397.

Electrolysis

The discovered instant invention relates to electro-chemically converting H₂O into O₂ and H₂. While there have been improvements in the technology of electrolysis and there have been many attempts to incorporate electrolysis with a combustion engine, wherein the hydrocarbon fuel is supplemented by H₂ produced by electrolysis, there has been no work with electrolysis to fuel a combustion engine wherein electrolysis is a significant source of O₂ and H₂. Previous work in electrolysis as electrolysis relate to combustion systems is herein referenced in U.S. Pat. No. 6,336,430, U.S. Pat. No. 6,338,786, U.S. Pat. No. 6,361,893, U.S. Pat. No. 6,365,026, U.S. Pat. No. 20 6,635,032 and U.S. Pat. No. 4,003,035.

Electricity

The discovered instant invention relates to the production of electricity. Mechanical energy to turn a generator (again, a generator means a generator, alternator or dynamo) is produced by the instant invention. This is while the steam energy for a steam driven generator may be produced by the instant invention; and, instant invention exhaust steam energy may drive a steam turbine, thereby turning a generator to create an electrical current.

The discovered instant invention presents a combustion turbine, wherein the exhaust gas is at least primarily if not totally H₂O. While there has been much work in the design of steam turbines, in all cases steam for the steam turbine is generated by heat transfer, wherein said heat for heat transfer is created by nuclear fission or hydrocarbon combustion. Previous work in steam turbine generation technology and exhaust turbine technology is herein referenced in: U.S. Pat. No. 6,100,600, U.S. Pat. No. 6,305,901, U.S. Pat. No. 6,332,754, U.S. Pat. No. 6,341,941, U.S. Pat. No. 6,345,952, U.S. Pat. No. 4,003,035, U.S. Pat. No. 6,298,651, U.S. Pat. No. 6,354,798, U.S. Pat. No. 6,357,235, U.S. Pat. No. 6,358,004 and U.S. Pat. No. 6,363,710, the closest being U.S. Pat. No. 4,094,148 and U.S. Pat. No. 6,286,315 B1.

The discovered instant invention relates to photovoltaic means to create electricity; wherein, said electricity is used in electrolysis to create at least one of H₂ and O₂ from H₂O, and wherein said H₂ and/or said O₂ is used in the instant invention. There are many means of photovoltaics, as is known in the art. There are many means wherein a photovoltaic cell may be used to create electricity for the electrolytic separation of H₂O into H₂ and O₂. Previous work in photovoltaic cells in relation to the production of H₂ is herein referenced in: U.S. Pat. No. 5,797,997, U.S. Pat. No. 5,900,330, U.S. Pat. No. 5,986,206, U.S. Pat. No. 6,075,203, U.S. Pat. No. 6,128,903, U.S. Pat. No. 6,166,397, U.S. Pat. No. 6,172,296, U.S. Pat. No. 6,211,643, U.S. Pat. No. 6,214,636, U.S. Pat. No. 6,279,321, U.S. Pat. No. 6,372,978, U.S. Pat. No. 6,459,231, U.S. Pat. No. 6,471,834, U.S. Pat. No. 6,489,553, U.S. Pat. No. 25 6,503,648, U.S. Pat. No. 6,508,929, U.S. Pat. No. 6,515,219 and U.S. Pat. No. 6,515,283.

H₂O Treatment Chemistry

The discovered instant invention relates to methods of controlling corrosion, scale and deposition in H₂O applications. U.S. Pat. No. 4,209,398 issued to Ii, et al., on Jun. 24, 1980, referenced herein, presents a process for treating H₂O to inhibit formation of scale and deposits on surfaces in contact with the H₂O and to minimize corrosion of the surfaces. The Ii, et al. process comprises mixing in the H₂O an effective amount of H₂O soluble polymer containing a structural unit that is derived from a monomer having an ethylenically unsaturated bond and having one or more carboxyl radicals, al least a part of said carboxyl radicals being modified, and one or more corrosion inhibitor compounds selected from the group consisting of inorganic phosphoric acids and H₂O soluble salts therefore. Phosphoric acids and H₂O soluble salts thereof, organic phosphoric acids and H₂O soluble salts thereof, organic phosphoric acid esters and H₂O-soluble salts thereof and polyvalent metal salts, capable of being dissociated to polyvalent metal ions in H₂O.

U.S. Pat. No. 4,442,009 issued to O'Leary, et al., on Apr. 10, 1984, referenced herein, presents a method for controlling scale formed from H₂O soluble calcium, magnesium and iron impurities contained in boiler H₂O. The method comprises adding to the H₂O a chelant and H₂O soluble salts thereof, a H₂O soluble phosphate salt and a H₂O soluble poly methacrylic acid or H₂O soluble salt thereof.

U.S. Pat. No. 4,631,131 issued to Cuisia, et al., on Dec. 23, 1986, referenced herein, presents a method for inhibiting formation of scale in an aqueous steam generating boiler system. Said method comprises a chemical treatment consisting essentially of adding to the H₂O in the boiler system scale-inhibiting amounts of a composition comprising a copolymer of maleic acid and alkyl sulfonic acid or a H₂O soluble salt thereof; hydroxyl ethylidene, 1-diphosphic acid or a H₂O soluble salt thereof and a H₂O soluble sodium phosphate hardness precipitating agent.

U.S. Pat. No. 4,640,793 issued to Persinski, et al., on Feb. 3, 1987, referenced herein, presents an admixture, and its use in inhibiting scale and corrosion in aqueous systems, comprising (a) a H₂O soluble polymer having a weight average molecular weight of less than 25,000 comprising an unsaturated carboxylic acid and an unsaturated sulfonic acid, or their salts, having a ratio of 1:20 to 20:1, and (b) at least one compound selected from the group consisting of H₂O soluble polycarboxylates, phosphonates, phosphates, polyphosphates, metal salts and sulfonates. The Persinski patent presents chemical combinations which prevent scale and corrosion.

Applicant attended the NASA Exploration Systems Mission Directorate (ESMD) Technology Exchange Conference in Galveston, Tex. on Nov. 14-15, 2007, wherein H₂ boil-off and later learned O₂ boil-off are individually and together a significant challenge to future Space flight to the Moon and to Mars, e.g. Project Constellation. It was presented by NASA that the Apollo Program after launch lost near 6-10 percent of stored hydrogen in a matter of days; said loss was due to the vapor pressure of H₂, e.g. H₂ boil-off. As of the filing of the instant invention, Applicant is efforting work with propulsion and cryogenic storage engineers at NASA to further application of the instant invention.

Further, presentations to NASA in regards to use of the WCT in combination with liquefaction demonstrated further a need in both heat rejection and electrical power for the WCT in combination with liquefaction. Many of the NASA Cryogenic Engineers have stated concerns regarding a means to both reject heat from liquefaction and to provide electrical power for instrumentation and control of liquefaction equipment.

### SUMMARY OF THE INVENTION

A primary object of the instant invention is to devise effective, efficient and economically feasible F&O Means.

A secondary object of the instant invention is to devise effective, efficient and economical means to create rotating mechanical energy and/or torque in Space.

A tertiary object of the instant invention is to devise effective, efficient and economical means to create electricity in Space.

Additional objects and advantages of the invention will be set forth in part in a description which follows and in part will be obvious from the description, or may be learned by practice of the invention.

The instant invention manages energy much more efficiently than the traditional combustion engine, which operates with hydrocarbons and air. This is especially the case with respect to the internal combustion engine (ICE). (Herein, ICE refers to either a piston driven engine or a turbine driven engine.) ICE, generally, in hydrocarbon combustion looses approximately 60 to 85 percent of available combustion energy in: heat losses from the engine, engine exhaust gases and unused mechanical energy. In contrast, the instant invention recaptures significant energy losses by converting otherwise lost energy (enthalpy, entropy and mechanical energy) into potential energy and internal energy. The instant invention generates additional power by utilizing the power of steam to increase engine efficiency while also using steam to cool the engine. It is further discovered that this instant invention provides thermodynamic capability to improve combustion efficiency while providing improved engine performance; wherein, said improved engine performance relates to both the produced engine power and the available power produced per cubic inch of engine displacement.

The discovered instant invention utilizes the energy of combustion of H₂ as the fuel with O₂ as the oxidizer. The combustion of H₂ with O₂ provides a combustion envelope having attributes which are somewhat different than those for any hydrocarbon. In comparison and contrast, the auto-ignition (combustion without a spark) temperature of H₂ is 585° C., while that of methane and propane is 540 and 487° C., respectively. The combustion envelope, by volume, for H₂ in air is near 4—75% (air is near 20% O₂), while that of methane and propane is near 5.3—15% and 2.1—9.5%, respectively. The explosive regions for H₂ and methane are 13—59% and 6.3—14%, respectively. It has, therefore, been discovered in the instant invention that H₂ provides a combustion envelope which allows for a cooling of combustion and of combustion exhaust gases in the combustion chamber, wherein said combustion envelope is not available with a hydrocarbon.

The combustion product of H₂ and O₂ is H₂O. This combustion reaction is somewhat similar to that of hydrocarbon combustion; however, carbon and nitrogen (from air) are removed from the reaction. The combustion of H₂ with O₂ produces H₂O, which is in stark contrast to the combustion of fossil fuels which produce, in addition to H₂O: oxides of carbon (COₓ), oxides of N₂ (NOₓ), and whenever the hydrocarbon is contaminated with S, oxides of sulfur (SOₓ).

Further, instant invention power capability is enhanced by the discovered capability of the instant invention to provide at least one of H₂ and of O₂ to the engine under pressure. This discovered capability of the instant invention provides a significant power capability which is not practical in a hydrocarbon air induced combustion system. Specifically, a hydrocarbon air induced combustion system must increase rpm to increase power; as, the combustion chemistry within each revolution is limited by the availability of oxidizer, O₂, in air at atmospheric pressure. In contrast, the discovered instant invention can provide O₂, as well as H₂, to combustion under pressure.

The discovered instant invention in a preferred embodiment stores H₂ in a cryogenic state, wherein said cryogenic state is preferably provided by a liquefaction means powered by an engine of the instant invention. It is it most preferred to store said cryogenic H₂ below its Joule Thompson Curve, thereby causing said H₂ to have a positive Joule Thompson coefficient (JtC) in order to provide further chilling and/or liquefaction of said H₂. While significantly improving the storage energy per unit volume, chilled or liquefied H₂ provides a discovered capability to provide H₂ to combustion under pressure. As the discovered instant invention is preferred to provide to combustion under pressure at least one of H₂ and of O₂, the discovered instant invention presents an engine which can increase power or available work about independent of rpm, as well as increase power or work directly dependant upon rpm. This discovered capability of the instant invention presents an engine which has a torque curve which is at least partially independent of rpm, or on a diagram of torque vs. rpm, the capability of a vertical or near vertical torque curve or the capability of a torque curve wherein at least one portion of the torque curve is about vertical, e.g. vertical torque curve.

Further still yet, as the discovered instant invention in still yet another preferred embodiment can operate “in diesel fashion” due to the auto-ignition temperature of H₂, which is near 585° C.; the discovered instant invention has the capability to further manage the cycle by the addition of either H₂, or O₂ during combustion. This discovered capability of the instant invention provides the ability of “a slow burn” during the power or expansion portion of the cycle.

Finally, the instant invention has been discovered to provide means of liquefaction for H₂ and/or O₂ storage. In Space, it is of high importance to maintain H₂ fuel mass; this is when H₂ and O₂ have significant vapor pressure. As depicted in FIG. 4, the instant invention provides means, e.g. method, system process and apparatus, to control H₂ fuel mass storage by means of liquefaction of H₂ vapor from H₂ fuel storage using available H₂ fuel and available O₂ oxidizer to power an engine of the instant invention, wherein said engine powers at least one compressor for liquefaction of at least one of H₂ and/or O₂.

### BRIEF DESCRIPTION OF THE DRAWINGS

A better understanding of the present invention can be obtained when the following descriptions of the preferred embodiments are considered in conjunction with the following drawings, in which:

FIG. 1 illustrates the refrigeration or liquefaction cycle.

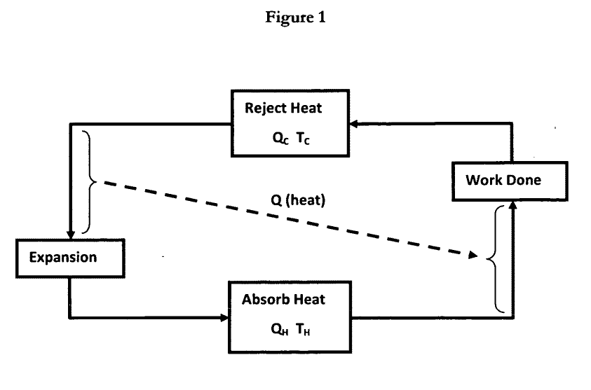

FIG. 2 illustrates a graphical representation of H₂ Boil-Off Data as presented by NASA at the November 2007 Galveston Conference.

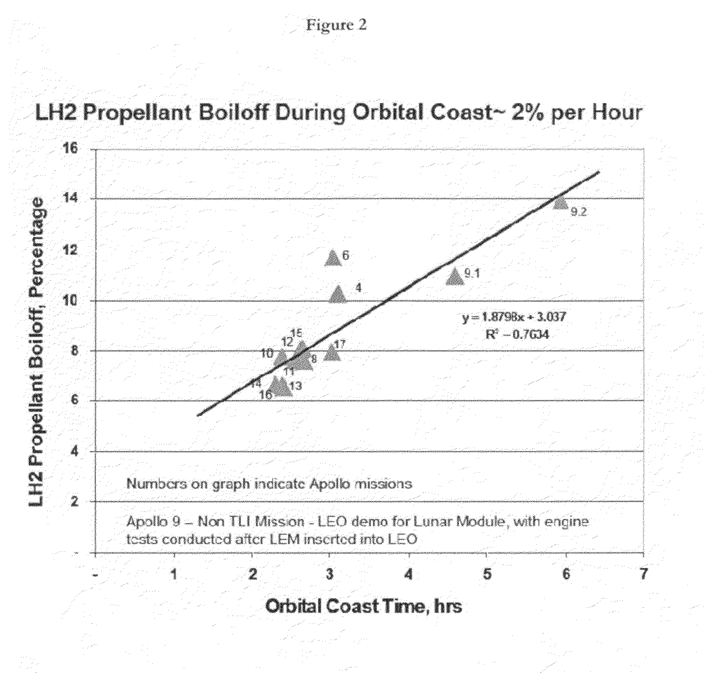

FIG. 3 is a legend for FIGS. 4 through 8.

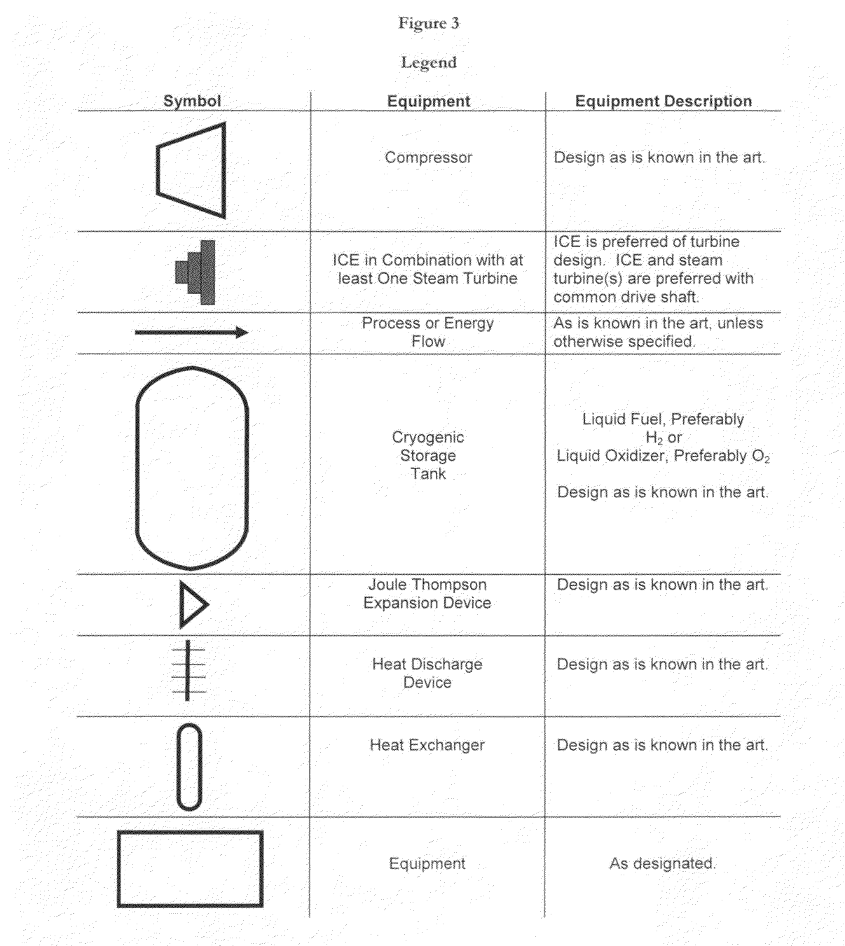

FIG. 4 presents in block diagram form the preferred engine and the preferred engine in combination with steam turbine(s).

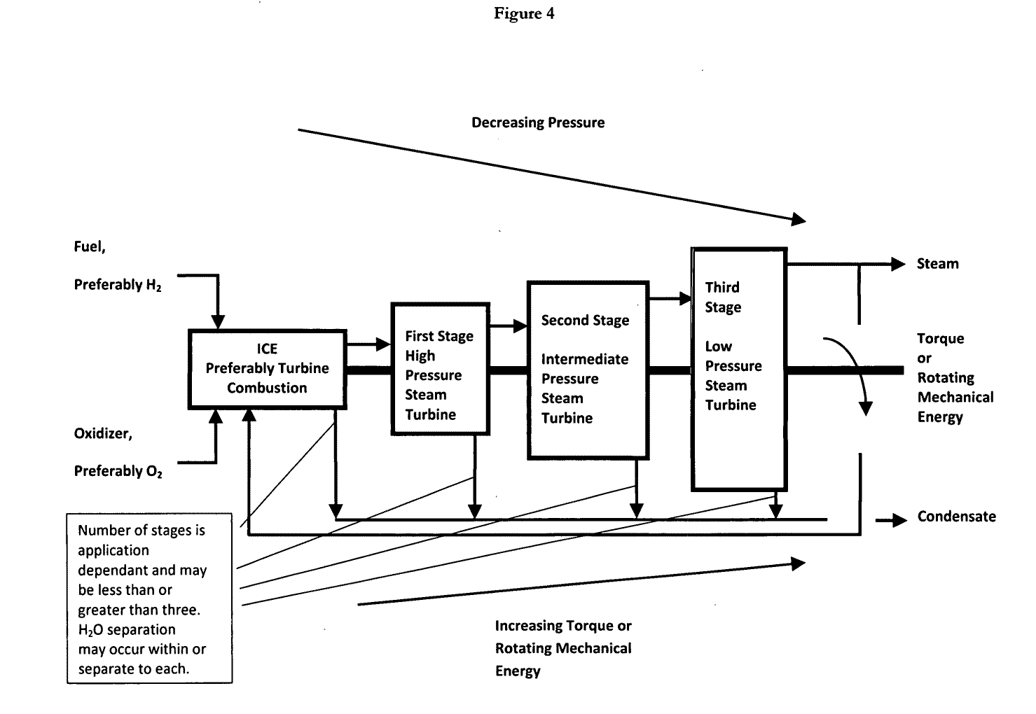

FIG. 5 illustrates in block diagram form preferred embodiments of Space F&O Means; wherein, the combustion engine/steam turbine can be replaced with a fuel cell.

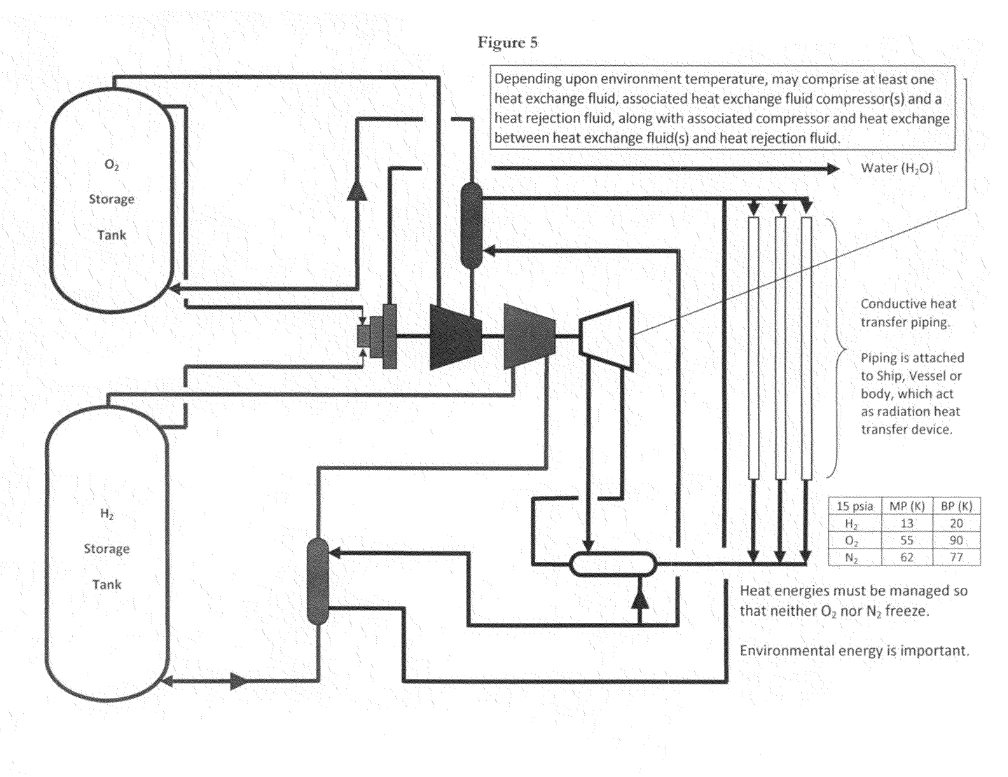

FIG. 6 illustrates in block diagram form the preferred embodiment of the instant invention as the instant invention applies to ICE.

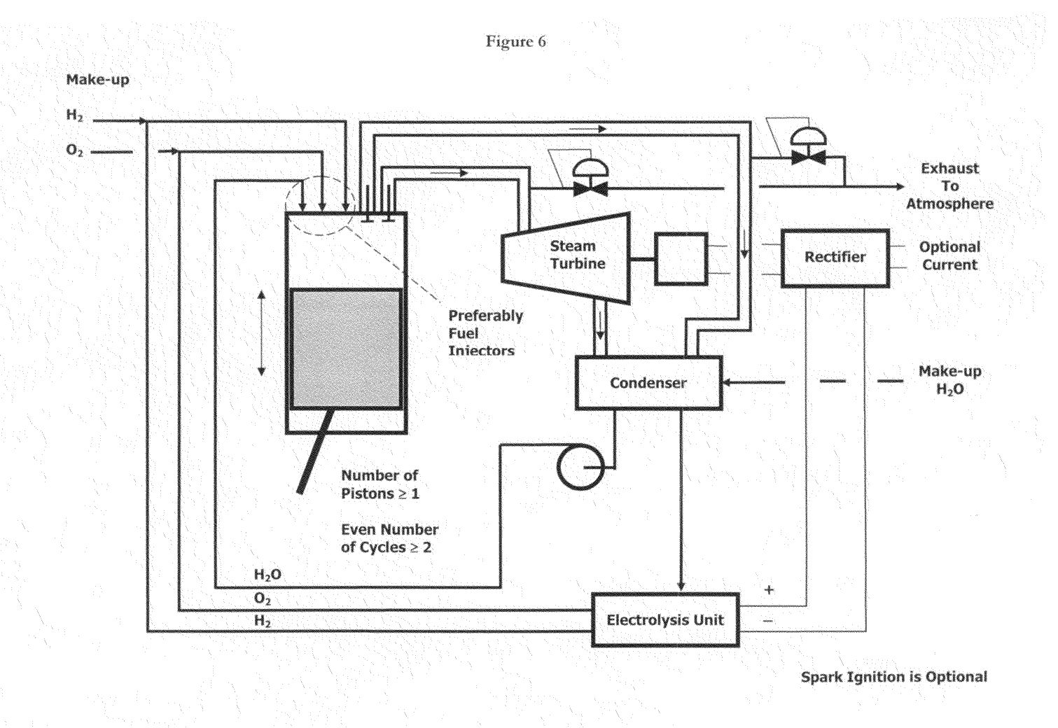

FIG. 7 presents a flow diagram of the instant invention operating in the configuration of a steam turbine electrical power plant. It is to be understood that the H₂ fuel and the O₂ oxidizer for combustion in the steam turbine electrical power plant may be obtained from storage of H₂ and/or O₂, or creation of H₂ and/or O₂ from the electrolysis of water. In Space, electrolysis of water is preferably performed with electrical energy obtained from photovoltaic cells or steam energy obtained from nuclear reaction.

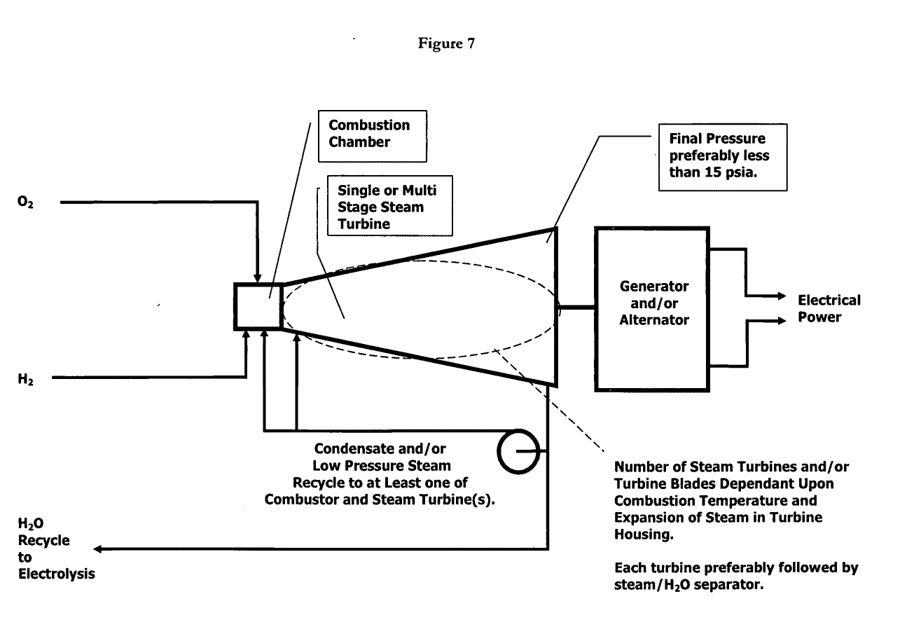

FIG. 8 presents a flow diagram of the instant invention comprising a heat transfer fluid and a heat rejection fluid; wherein, the flow diagram can be modified for numerous heat transfer fluids, depending upon environment temperature.

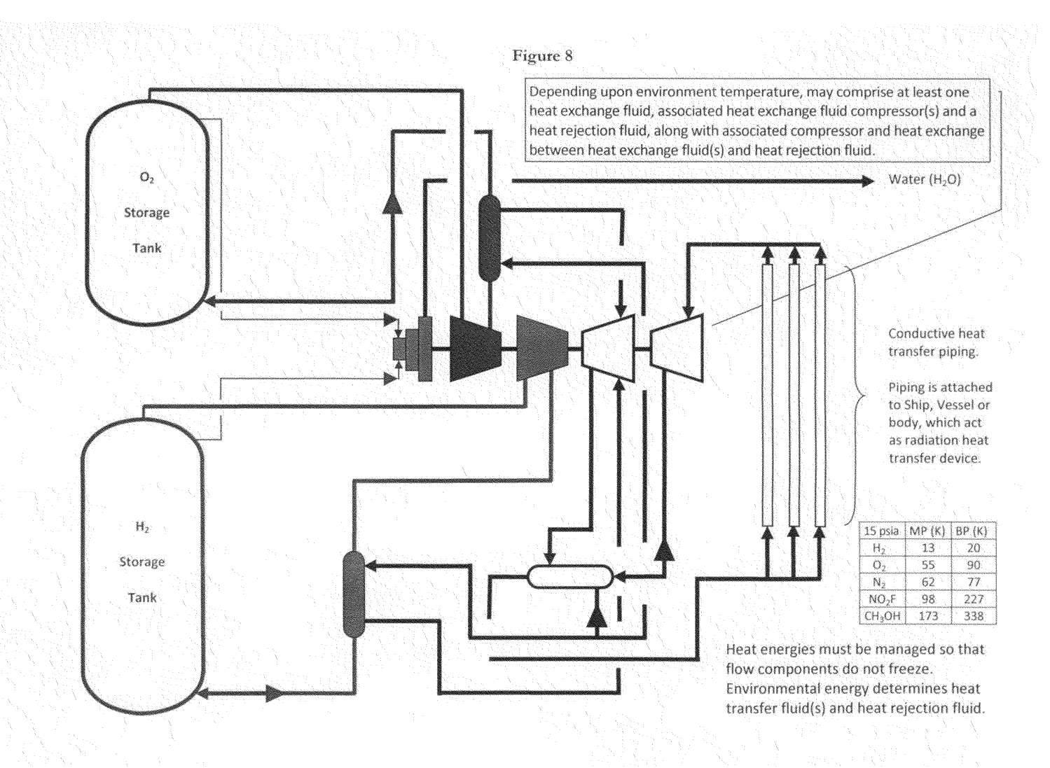

### DETAILED DESCRIPTION OF THE PREFERRED EMBODIMENTS

Timing of the instant invention is significant since humankind is preparing to travel to the Moon and to Mars. Timing of the instant invention is significant as a means is needed to improve H₂ and/or O₂ storage efficacy for extended Space travel. Timing of the instant invention is significant as a means of managing fuel and oxidizer volatiles in Space flight is needed for extended Space flight; this is especially so when at least one of said fuel is H₂ and said oxidizer is O₂. Timing of the instant invention is significant as a means is needed to provide power to liquefaction means as a means to improve H₂ and/or O₂ storage efficacy. Timing of the instant invention is significant as a means is needed to reject heat from liquefaction means as a means to improve H₂ and/or O₂ storage efficacy. Timing of the instant invention is significant as a means to power liquefaction means as a means to improve H₂ and/or O₂ storage. Timing of the instant invention is significant as travel to other planets by humanity requires improved power/engine mass ratios in order to improve the effectiveness of payloads to other worlds.

The instant invention utilizes H₂ with O₂ to create energy. It is preferred that the methods, process, systems and apparatus of the instant invention produce at least one selected from a list consisting of: rotating mechanical energy, power, torque, electricity, steam and any combination therein. The instant invention engine utilizes as an embodiment H₂O in the form of steam to cool a combustion engine, while utilizing the steam (hot gaseous H₂O) produced during combustion and/or during cooling as a means of energy transfer and/or energy conservation by converting at least a portion of said steam energy into mechanical energy. The combustion engine is defined herein as a volume wherein combustion takes place or wherein the products of combustion create at least one selected from the list consisting of energy, power, torque, steam and any combination therein. Said recycled potential energy is to be at least one of O₂ and H₂.

It is a preferred embodiment that combustion is at least one of: piston internal combustion, open flame (heating) combustion and turbine combustion, as these applications are known in the art of combustion science. It is preferred that said combustion create at least one of mechanical rotating energy, torque and steam energy. It is preferred that said steam energy create at least one of mechanical rotating energy and torque. It is preferred that said mechanical rotating energy or torque turn a generator to make electricity.

Engine

A preferred embodiment of the instant invention is an engine combusting H₂ and O₂ from at least one storage tank. It is preferred that the H₂ and the O₂ be from individual storage tanks storing the H₂ and the O₂ separately. A preferred embodiment of the instant invention is an engine combusting H₂ and O₂; wherein, the engine creates rotating mechanical energy. A preferred embodiment of the instant invention is an engine combusting H₂ and O₂; wherein, the engine creates rotating mechanical energy; and wherein, at least a portion of the rotating mechanical energy is converted into electrical energy by the turning of a generator by the rotating mechanical energy.

Engine and Steam Turbine

It is discovered that the exhaust of an engine combusting H₂ and O₂ will be H₂O. It is preferred that the exhaust of an engine combusting H₂ and O₂ pass through at least one steam turbine. It is preferred that the exhaust of an engine combusting H₂ and O₂ pass through at least one steam turbine; wherein, said engine and said steam turbine share a rotating shaft to create rotating mechanical energy. It is preferred that the exhaust of an engine combusting H₂ and O₂ pass through at least one steam turbine; wherein, said engine and said steam turbine share a rotating shaft to create rotating mechanical energy such that the shared rotating shaft create a shared rotating mechanical energy that is greater than that of the engine alone. It is most preferred that the exhaust of an engine combusting H₂ and O₂ pass through a number of steam turbine(s). It is most preferred that the exhaust of an engine combusting H₂ and O₂ pass through a number of steam turbine(s), wherein said engine and said steam turbine(s) share a rotating shaft to create rotating mechanical energy such that the shared rotating mechanical energy is greater than that of the engine alone. It is most preferred that the exhaust of an engine combusting H₂ and O₂ pass through a number of steam turbine(s) such that the final steam turbine operates near or below ambient pressure. It is most preferred that the exhaust steam from the steam turbine(s) be at least partially used to control temperature in at least one of the engine and at least one of the steam turbines.

Efficiency

The instant invention utilizes electro-chemical pathways to convert H₂O into O₂ and H₂; wherein, the electrical energy for these pathways is obtained from at least one of: cooling the engine, engine exhaust gas energy, combustion output rotating mechanical energy, photovoltaic energy and the energy of air or H₂O motion. Given that the efficiency of traditional combustion engines (especially the internal combustion engine) is only approximately 15 to 25 percent (near 20 percent) efficient, the instant invention can significantly increase engine efficiency.

It is discovered that the theoretical limit of efficiency for the discovered engine/steam turbine combination is in excess of that obtained by the engine alone or previous attempts to combine a hydrocarbon combustion engine with steam turbines. Efficiency is approximately limited to the conversion of enthalpy and entropy in engine exhaust to rotating mechanical energy by the steam turbine(s). This theoretical limit presented is a theoretical efficiency limit of the instant invention to be near approximately 50-85 percent.

Liquefaction

While liquefaction is commonly used in the chemical industry, liquefaction is not known to be previously been used in Space or in Space F&O Management. It is preferred that a liquefaction unit liquefy volatiles from at least one of fuel and of oxidizer storage. It is most preferred that said fuel is H₂ and said oxidizer is O₂.

It is preferred to power a liquefaction unit with at least one of rotational mechanical energy and electricity. It is preferred that said rotating mechanical energy or electricity power at least one compressor. It is preferred that at least a portion of said rotational mechanical energy and/or electricity be generated by an engine combusting H₂ and O₂ from at least one storage tank. It is preferred to perform liquefaction upon at least one of H₂ and O₂ from at least one storage tank; wherein, the liquefaction is powered by an engine; and wherein, the engine converts at least a portion of the at least one of H₂ and O₂ from the at least one storage tank into said rotating mechanical energy or electricity. It is preferred to perform liquefaction upon at least one of H₂ and O₂ from at least one storage tank; wherein, the liquefaction is powered by rotating mechanical energy; wherein, the rotating mechanical energy is created by an engine and at least one steam turbine; wherein, the engine converts at least a portion of at least one of the H₂ and the O₂ from the at least one storage tank into the rotating mechanical energy or electricity; and wherein, the steam turbine converts steam from the engine into the rotating mechanical energy. It is preferred to perform liquefaction upon at least one of H₂ and O₂ from at least one storage tank; wherein, the liquefaction is powered rotating mechanical energy; wherein an engine and at least one steam turbine create the rotating mechanical energy; wherein, the engine converts at least a portion of the H₂ and the O₂ from at least one storage tank into the rotating mechanical energy or electricity; wherein, the steam turbine converts steam from the engine into the rotating mechanical energy; and wherein, electricity is created by a generator or alternator turned by the rotating mechanical energy created by at least one of said engine and said steam turbine. It is an embodiment to perform liquefaction upon at least one of H₂ and O₂ from at least one storage tank; wherein, the liquefaction is powered by a fuel cell and the fuel cell converts at least one of H₂ and/or O₂ from the at least one storage tank into said rotating mechanical energy or power. It is most preferred that the exhaust from said last compressor be at or below 15 psia.

Liquefaction may be powered photo-voltaic (PV) means, including a PV Array.

It is preferred to perform liquefaction of H₂; wherein, at least one compressor compresses H₂ prior to a Joule Thompson Effect of the H₂. It is preferred to perform liquefaction of O₂; wherein, at least one compressor compresses O₂ prior to a Joule Thompson Effect of the O₂.

A vacuum or near vacuum exists in Space. Therefore, heat rejection is an important criterion to a liquefaction system or unit in Space. It is a preferred embodiment to reject heat energy from at least one liquefaction loop; wherein, the liquefaction loop comprises a compressor; wherein, the liquefaction loop comprises a Joule Thompson Effect; and wherein, the heat rejection is after compression and before the Joule Thompson Effect. It is a preferred embodiment to reject energy from at least one liquefaction loop; wherein, the at least one liquefaction loop comprises at least one of a fuel and O₂; wherein, the liquefaction loop comprises a compressor; and wherein, the heat rejection is after compression and before the Joule Thompson Effect. It is preferred that said heat rejection be performed by radiation of the fluid (herein a fluid may comprise a liquid, a gas or a liquid and a gas) in the liquefaction loop, wherein the radiation is performed to the environment. It is preferred that said heat rejection be performed by inclusion of a heat rejection fluid; wherein, the heat rejection fluid have heat exchange with the fluid in the liquefaction loop; and, wherein the heat exchange perform the heat rejection. It is preferred that said heat rejection fluid reject heat by radiation; wherein, the radiation is performed to the environment. It is preferred that a liquefaction loop perform heat rejection of a fluid of the fuel or of O₂ by inclusion of a heat rejection fluid; wherein, the heat rejection fluid have heat exchange with the fluid in the liquefaction loop; wherein, the heat rejection fluid pass through at least one compressor within a liquefaction or refrigeration loop; and wherein, the heat rejection fluid rejects heat by at least one of conduction and radiation. It is preferred that said conduction be to at least one selected from the list consisting of a: Space Ship, Space Vessel, Non-Earth Body, and any combination therein. It is preferred that said Space Ship or Space Vessel Ship or Non-Earth Body release said conducted heat by radiation. It is most preferred that said engine drive the at least one compressor for the heat rejection fluid. It is most preferred that said engine and at least one steam turbine drive the at least one compressor for the heat rejection fluid. It is most preferred that the heat rejection fluid comprise nitrogen (N₂). It is preferred that said fuel comprise H₂.

It is most preferred that the at least one compressor for the liquefaction of fuel, the at least one compressor for the liquefaction of O₂ and the at least one compressor for the liquefaction of said heat rejection fluid be driven or powered by said engine. It is most preferred that the at least one compressor for the liquefaction of fuel, the at least one compressor for the liquefaction of O₂ and the at least one compressor for the liquefaction of said heat rejection fluid be driven or powered by said engine and at least one of said steam turbine(s). It is most preferred that the at least one compressor for the liquefaction of fuel, the at least one compressor for the liquefaction of O₂ and the at least one compressor for the liquefaction of said heat rejection fluid be driven or powered by a common rotating shaft. It is preferred that said fuel comprise H₂.

Environmental Temperature and Heat Transfer Fluids

It is preferred that there be at least one heat transfer fluid in combination with at least one heat rejection fluid, depending on temperature of the environment within which to reject heat. The greater the environmental temperature, the greater will be required the number of heat transfer fluids prior to utilization of at least one heat rejection fluid. It is most preferred that the at least one compressor for the liquefaction of fuel and/or the at least one compressor for the liquefaction of O₂, the at least one compressor for the liquefaction of said at least one heat transfer fluid and the at least one compressor for liquefaction of said at least one heat rejection fluid be driven or powered by said engine. It is most preferred that the at least one compressor for the liquefaction of fuel and/or the at least one compressor for the liquefaction of O₂, the at least one compressor for the liquefaction of said at least one heat transfer fluid and the at least one compressor for liquefaction of said at least one heat rejection fluid be driven or powered by said engine and at least one of said steam turbine(s). It is most preferred that the at least one compressor for the liquefaction of fuel and/or the at least one compressor for the liquefaction of O₂, the at least one compressor for the liquefaction of said at least one heat transfer fluid and the at least one compressor for liquefaction of said at least one heat rejection fluid be driven or powered by a common rotating shaft. It is preferred that said fuel comprise H₂.

Cryogenic Storage of Fuel and/or O₂

It is a preferred embodiment to store at least one of O₂ and fuel at a temperature of less than 0° C., herein referred to as cryogenic O₂ and cryogenic fuel, respectively. It is most preferred to store the fuel at a temperature of less than the boiling point of the fuel, hereinafter referred to as cryogenic liquefied fuel. It is most preferred to store O₂ at a temperature of less than the boiling point of O₂, hereinafter referred to as cryogenic liquefied O₂. It is preferred that said cryogenic liquefied O₂ and/or cryogenic liquefied fuel be stored with a refrigeration and/or liquefaction loop. It is preferred that said refrigeration and/or liquefaction loop be powered by the stored cryogenic fuel and O₂. It is most preferred that said cryogenic O₂ and/or cryogenic H₂ be stored as a liquid or plasma. It is preferred that said fuel comprise H₂.

Gel

It is preferred to improve the handling of H₂ by creating a H₂ gel. Said H₂ gel is to be formed by the inclusion of at least one selected from a list consisting of: H₂O, O₂ and methane in said H₂, wherein said H₂ is in a cryogenic liquefied state such that said inclusion is in a frozen crystalline state, thereby causing said H₂ and inclusion to form and behave as a gel. It is preferred to improve the handling of O₂ by creating an O₂ gel. Said O₂ gel is to be formed by the inclusion of at least one selected from a list consisting of: H₂O and methane in said O₂, wherein said O₂ is in a cryogenic liquefied state such that said inclusion is in a frozen crystalline state, thereby causing said O₂ and inclusion to behave as a gel.

Insulation

It is preferred to insulate at least one of an engine and a steam turbine powered by at least one of said fuel and said oxidizer.

It is most preferred that said insulation be that as is known in the art. It is preferred that said insulation be located around the engine. It is preferred that said insulation be located around each combustion chamber. It is preferred that said insulation be located around each steam turbine.

In the case of an internal combustion engine (ICE), it is preferred that each combustion chamber be insulated with insulation materials as known in the art of insulation; wherein, the insulation reduces the rate of heat transfer from the combustion chamber to the surrounding environment and/or to the engine block. In the case of an ICE, it is preferred that each combustion chamber be insulated with insulation materials as known in the art of insulation; wherein, the insulation materials slow the rate of heat transfer from said combustion chamber via a shape of insulation material which surrounds said combustion chamber. In the case of an ICE, it is preferred that each combustion chamber be insulated with insulation materials as known in the art of insulation; wherein, a turbine comprises a layer of insulation to reduce the rate of heat transfer from the combustion chamber. In the case of an ICE, it is preferred that each combustion chamber be insulated; wherein, the external surface temperature of said ICE is at least about less than 300 K. In the case of an ICE, it is most preferred that each combustion chamber be insulated; wherein, the external surface temperature of said ICE is at least about less than 100 K. In the case of an ICE, it is preferred that each combustion chamber be insulated; wherein, the external surface temperature of said ICE is within 50 K of the temperature of the environment. In the case of an ICE, it is most preferred that each combustion chamber be insulated; wherein, the external surface temperature of said ICE is within 10 K of the temperature of the environment.

In the case of a steam turbine, it is preferred that the turbine be insulated with insulation materials as known in the art of insulation; wherein, said insulation materials slow the rate of heat transfer from said steam turbine. In the case of a steam turbine, it is preferred that the steam turbine be insulated with insulation materials as known in the art of insulation; wherein, the insulation reduces the rate of heat transfer from the steam turbine to the surrounding environment. In the case of a steam turbine, it is preferred that each combustion chamber be insulated; wherein, the external surface temperature of said turbine is at least about less than 300 K. In the case of a steam turbine, it is most preferred that each combustion chamber be insulated, wherein the external surface temperature of said turbine is at least about less than 100 K. In the case of a steam turbine, it is preferred that each combustion chamber be insulated; wherein, the external surface temperature of said steam turbine is within 50 K of the temperature of the environment. In the case of a steam turbine, it is most preferred that each combustion chamber be insulated; wherein, the external surface temperature of said steam turbine is within 10 K of the temperature of the environment.

It is preferred that ceramic materials are used. A ceramic material is herein defined as a compound comprising at least one metal, other than iron, which forms a crystalline structure; wherein, said crystalline structure is formed by heat.

Steam Conversion to H₂

It is preferred to convert gaseous H₂O, steam, into H₂ utilizing corrosion to chemically convert the steam to H₂. Said corrosion is to utilize the O₂ in the steam to convert at least one metal to its metal oxide, while releasing H₂. It is most preferred to produce an electromotive potential in at least one metal to drive the corrosion process for the at least one metal to its metal oxide, while producing H₂. It is most preferred that said electromotive potential be anodic.

Electrolysis

It is preferred to electro-chemically convert H₂O into O₂ and H₂. It is to be understood that under the best of engineered circumstances, the electrical energy required by electrolysis to convert H₂O into O₂ and H₂ will be greater than the energy obtained by the combustion of O₂ and H₂. However, electrolysis allows for significant improvements in the thermodynamic efficiency of combustion by reclaiming energy which would otherwise be lost.

Energy Recycle

As a steam turbine taking the engine exhaust will create a back pressure situation to the engine, thereby lessening engine power and efficiency, it is preferred that the instant invention include a condenser, thereby evacuating the combustion chamber and/or steam turbine, and thereby minimizing combustion chamber and/or turbine pressure. It is most preferred that the condenser for steam exiting the steam turbine and the condenser for the steam evacuating the combustion chamber be the same condenser. It is an embodiment that the condenser for steam exiting the steam turbine be separate from the condenser for the steam evacuating the combustion chamber. It is preferred that at least a portion of the H₂O in said condenser(s) be transferred to an electrolysis unit. It is preferred that the H₂O in said electrolysis unit be converted to H₂ and O₂ by electrolysis. It is preferred that at least a portion of said H₂ converted in said electrolysis unit be used as a fuel in said combustion chamber. It is preferred that at least a portion of said O₂ converted in said electrolysis unit be used as an oxidizer in said combustion chamber. It is most preferred that the electrical energy of said electrolysis unit be obtained from at least one generator; wherein, the power to turn said at least one generator be obtained from at least one selected from a list consisting of: rotating mechanical energy created by an engine powered by at least one of H₂ and O₂ from at least one storage tank, rotating mechanical energy created by a steam turbine turned by the exhaust gases (steam) from an engine powered by at least one of H₂ and O₂ from at least one storage tank, rotating mechanical energy created by moving wind energy, rotating mechanical energy created by moving H₂O energy, and any combination therein.

Potential Energy/Fuel Generation

It is preferred that at least a portion of the H₂ and/or the O₂ from the electrolysis of H₂O be used in an ICE. It is preferred that at least a portion of the H₂ and/or the O₂ from the electrolysis of H₂O be used in a fuel cell. It is most preferred that at least a portion of the H₂ and/or O₂ from the electrolysis of H₂O be used in an ICE using H₂ as a fuel and O₂ as an oxidizer; wherein, said engine is cooled by the addition of H₂O to the combustion chamber. It is most preferred that said engine or said fuel cell power a liquefaction unit for storage of said H₂ or said O₂.

Electricity Generation

It is preferred to generate electrical energy; wherein, said electrical energy (electricity) is created from a generator; wherein, said generator is turned by rotating mechanical energy; and wherein, said rotating mechanical energy is created by an engine using H₂ as a fuel and O₂ as an oxidizer.

It is a preferred embodiment that said rotating mechanical energy enter a transmission, wherein said transmission engage in a manner that is inversely proportional to the torque and/or work load of the engine; wherein, said transmission output mechanical rotating energy turn said generator to create said electrical energy. Said transmission is to be as is known in the art. It is most preferred that said transmission engage a flywheel capable of storing rotational kinetic energy; wherein, said flywheel turns said generator.

It is preferred to generate electricity; wherein, said electricity is created from a generator; wherein, said generator is turned by a steam turbine; wherein, said steam turbine is turned by steam; wherein, said steam is created by an engine using H₂ as a fuel and O₂ as an oxidizer. It is preferred to generate electricity; wherein, said electricity is created from a generator; wherein, said generator is turned by a steam turbine; wherein, said steam turbine is turned by steam; wherein, said steam is created by an engine using H₂ as a fuel and O₂ as an oxidizer; wherein, said engine is cooled by the addition of H₂O to the combustion chamber. It is preferred that said steam turbine(s) be in such a configuration that said steam be the exhaust of said engine. It is preferred that said steam energy be converted into rotational mechanical energy via a turbine to turn said generator or an alternator. It is most preferred that there be at least one steam turbine and that said steam turbine(s) create mechanical energy to turn at least one of said generator(s) or alternator(s).

It is preferred to generate electricity by the energy of light using photovoltaic cells; wherein, said electricity is used to electrochemically convert H₂O into H₂ and O₂; and wherein, at least one of said H₂ and O₂ is used in said engine.

It is preferred to generate electricity by nuclear means; wherein, said nuclear means is defined herein as the generation of heat energy generated from the radioactive decay of at least one element or the generation of He from H₂; wherein, said heat energy is used to create steam energy; wherein, said steam energy is used to turn at least one steam turbine; and wherein, said steam turbine turns at least one generator to create said electricity. It is preferred that said electricity is used to electrochemically convert H₂O into H₂ and O₂; wherein, at least one of said H₂ and O₂ is used in said engine.

It is preferred to generate electricity; wherein, said electricity is generated by at least one selected from a list consisting of: photovoltaic cells, moving air, moving H₂O, nuclear means and any combination therein; wherein, said electricity is at least partially utilised in an electrolysis unit to convert H₂O to H₂ and O₂; and wherein, at least a portion of at least one of said H₂ and O₂ is used in said engine.

H₂O Chemistry

H₂O is the most efficient and economical method of storing O₂ and/or H₂. Electrolysis is the most preferred method of converting H₂O into combustible H₂ and O₂. Electrolysis is best performed with a dissolved electrolyte in the H₂O; the dissolved electrolyte, most preferably a salt, will improve conductivity in the H₂O, thereby reducing the required electrical energy to perform electrolysis. It is an embodiment to perform electrolysis upon H₂O that contains an electrolyte. It is preferred to perform electrolysis upon H₂O that contains a salt. It is most preferred to perform electrolysis upon H₂O that contains polyelectrolytes.

However, many dissolved cation(s) and anion(s) combination(s) can precipitate over time reducing the efficiency of electrolysis. Further, as temperature is increased, hard H₂O contaminants may precipitate; therefore, it is preferred to add a dispersant to the H₂O to prevent scale.

Dispersants are low molecular weight polymers, usually organic acids having a molecular weight of less than 25,000 and preferably less than 10,000. Dispersants are normally polyelectrolytes. Dispersant chemistry is based upon carboxylic chemistry, as well as alkyl sulfate, alkyl sulfite and alkyl sulfide chemistry; it is the oxygen (O) atom that creates the dispersion, wherein O takes its form in the molecule as a carboxylic moiety and/or a sulfoxy moiety. Dispersants that can be used in the instant invention which contain the carboxyl moiety comprise at least one selected from a list consisting of: acrylic polymers, acrylic acid, polymers of acrylic acid, methacrylic acid, maleic acid, fumaric acid, itaconic acid, crotonic acid, cinnamic acid, vinyl benzoic acid, any polymers of these acids and any combination therein. Dispersants that can be used in the instant invention contain the alkyl sulfoxy or allyl sulfoxy moieties include any alkyl or allyl compound, comprise at least one selected from a list consisting of: SO, SO₂, SO₃ and any combination therein. Due to the many ways in which an organic molecule can be designed to contain the carboxyl moiety and/or the sulfoxy moiety, it is an embodiment that any H₂O soluble organic compound containing at least one of a carboxylic moiety and/or a sulfoxy moiety may be added to the H₂O in the instant invention. (This is with the knowledge that not all dispersants have equivalent dispersing properties. Acrylic polymers exhibit very good dispersion properties, thereby limiting the deposition of H₂O soluble salts and are most preferred embodiments as a dispersant. The limitation in the use of a dispersant is in the H₂O solubility of the dispersant in combination with its carboxylic nature and/or sulfoxy nature.)

H₂O is inherently corrosive to metals. H₂O naturally oxidizes metals, some with a greater oxidation rate than others. To minimize corrosion, it is preferred that the H₂O have a pH of equal to or greater than 7.5, wherein the alkalinity of the pH is obtained from the hydroxyl anion. Further, to prevent corrosion or deposition of H₂O deposits on steam turbines, it is preferred to add a corrosion inhibitor to the H₂O. It is an embodiment to utilise nitrogen (N) containing corrosion inhibitors, such as hydrazine, as is known in the art of H₂O treatment.

While corrosion inhibitors are added to H₂O to prevent corrosion, a chelant is preferred to both prevent corrosion and complex, as well as prevent the deposition of, a cation, including hardness and heavy metals. A chelant or a chelating agent is a compound having or forming a heterocyclic ring wherein at least two kinds of atoms are joined in a ring. Chelating is forming a heterocyclic ring compound by joining a chelating agent to a metal ion. Most chelants are polyelectrolytes. It is a preferred embodiment to use a chelant in the H₂O and or the steam to control mineral deposition. It is preferred to add to the H₂O and/or the steam at least one selected from a list consisting of a: phosphate, phosphate polymer, phosphate monomer and any combination thereof. Said phosphate polymers consist of, but are not limited to, phosphoric acid esters, metaphosphates, hexametaphosphates, pyrophosphates and/or any combination thereof. Phosphate polymers are particularly effective in dispersing magnesium silicate, magnesium hydroxide and calcium phosphates. Phosphate polymers are particularly effective at corrosion control. With proper selection of a polymer, along with maintaining an adequate polymer concentration level, the surface charge on particle(s) can be favorably altered. In addition to changing the surface charge, polymers also function by distorting crystal growth.

Operating Pressure Management

An engine recycling exhaust gas energy has the potential to develop unintended operating situations; wherein, the operating pressure becomes greater than the design pressure of the equipment employed; and, any such situation can be a significant safety issue. Recycling of exhaust gas energy from an engine which may operate in a situation of changing exhaust gas conditions, comprises a situation wherein the pressure of said exhaust gas should be managed in order to protect equipment and manage equipment operation. Operating pressure management is to include a pressure management device, herein termed a pressure control device, which may include any type of pressure controller and/or pressure relief device as is known in the art of managing gas pressure. Such devices can include, yet are not limited to: a pressure control valve, a pressure control loop including a valve, a relief valve, a rupture disc and any combination therein. It is an embodiment to provide a pressure control device to an engine using H₂ as a fuel and O₂ as an oxidizer. It is an embodiment to provide a pressure control device to an engine using H₂ as a fuel and O₂ as an oxidizer; wherein, said engine is cooled by the addition of H₂O to the combustion chamber. It is an embodiment to provide a pressure control device to an engine using H₂ as a fuel with air as the oxidizer; wherein, said air is in excess over that required to perform combustion to limit NOₓ formation. It is a preferred embodiment to provide a pressure control device to an engine using H₂ as a fuel and O₂ as an oxidizer; wherein, the exhaust gas of said engine comprises steam, and wherein said steam turns a steam turbine. It is a preferred embodiment to provide a pressure control device to an engine using H₂ as a fuel and O₂ as an oxidizer; wherein, said engine is cooled by the addition of H₂O to the combustion chamber; wherein, the exhaust gas of said engine comprises steam; and wherein, said steam turns a steam turbine.

Engine, H₂O and Lubricant Heating

In Space, as the ambient temperature is often below the freezing point of water and of an engine lubricant, it is preferred to provide a means of heating to at least one of: any engine block, engine water and engine lubricant. It is most preferred that said means of heating be accomplished by a heating element powered by a fuel cell and/or of combustion heat energy obtained from the instant invention. It is most preferred that said fuel cell be powered by H₂ and O₂. It is most preferred that said fuel cell provide said means of heating via a resistive wire type of heating element, as is known in the art. It is most preferred that at least one of said engine block, said engine H₂O and said engine lubricant be insulated from ambient temperature. It is most preferred that said fuel cell be a fuel cell as is known in the art.

Apparatus

Said combustion engine may be of any type; wherein, combustion is performed to generate at least one selected from the list consisting of: rotating mechanical energy, mechanical torque, heat, thrust, electricity, and any combination therein. It is preferred that said fuel to the engine or the fuel cell have a flow. O₂ flowing to the engine or fuel cell is to have a flow. There is to be an optional device means to measure said H₂ flow and an optional means to measure said O₂ flow, such that a proportional signal in relation to said flows is sent to a controller from each of said H₂ flow measuring device and said O₂ flow measuring device. H₂ flowing to the combustion chamber is to have at least one flow control valve. O₂ flowing to the combustion chamber is to have at least one flow control valve. Each H₂ storage tank and/or each O₂ storage tank is to have a means to measure pressure within the storage tank. Each flow measuring device and/or flow control valve is to create a signal. Each pressure measuring device is to have a means to create a pressure signal. In the case of an engine, a device to measure engine rpm is to be provided. Said engine rpm measuring device is to create an engine rpm signal. A device to measure fuel or H₂ compressor rpm is to be provided. A device to measure O₂ compressor rpm is to be provided. A device to measure Heat Rejection Fluid compressor rpm is to be provided. Fuel or H₂ compressor rpm measuring device is to create a fuel compressor rpm signal. O₂ compressor rpm measuring device is to create an O₂ compressor rpm signal. A device to measure engine temperature or fuel cell temperature is to be provided. Each temperature measuring device is to have means of providing a temperature measurement signal.

A controller is to have as input said H₂ flow signal or said H₂ flow value position in combination with said H₂ Storage Tank Pressure and said O₂ flow signal or said O₂ flow value position in combination with said O₂ Storage Tank Pressure. Said controller is to have an H₂ Storage Tank Pressure set-point. Said controller is to have an O₂ Storage Tank Pressure set-point. Said controller is to create an rpm set-point for the fuel or H₂ Liquefaction compressor which is dependent upon the difference between the corresponding H₂ Storage Tank Pressure and the fuel or H₂ Storage Tank Pressure set-point. Said controller is to create an rpm set-point for the O₂ Liquefaction compressor which is dependent upon the difference between the corresponding O₂ Storage Tank Pressure and the O₂ Storage Tank Pressure set-point. Said controller is to create an rpm set-point for the Heat Rejection Fluid compressor which is dependent upon the difference between the corresponding H₂ Storage Tank Pressure and the H₂ Storage Tank Pressure set-point in combination with the O₂ Storage Tank Pressure and the O₂ Storage Tank Pressure set-point. Said controller is to compare said combustion set-point to each rpm set-point, sending a proportional signal to said fuel or H₂ flow control valve that is in proportion to the difference in said set-point and the said fuel or H₂ flow, thereby proportioning said fuel or H₂ flow control valve. The controller is to compare said O₂ flow signal to a fuel or H₂ ratio set-point, providing a proportional signal to said O₂ flow control valve, wherein said fuel or H₂ flow and said O₂ flow are such that the molar ratio of fuel or H₂ to O₂, which in the case of H₂ is approximately 2:1.

In the case wherein said temperature signal is less than a warm temperature set-point, it is preferred that said controller turn on a heating device for at least one of said engine and said compressor(s).

In the case wherein the temperature signal is about equal to or greater than a warm temperature set-point, it is preferred that said controller turn of the heating device.

In the case wherein the temperature signal is greater than a hot temperature set-point, it is preferred that said controller send a signal to remove insulation from the engine proportionately to the temperature signal being greater than the hot temperature set-point.

In the case wherein the temperature signal is greater than a hot temperature set-point, it is preferred that said controller send a signal to a steam flow control value, such that steam from the steam turbine(s), most preferably the exhaust, is recycled to said engine to regulate or control engine combustion temperature.

In the case wherein the temperature signal is greater than a very hot temperature set-point, it is preferred that said controller send a signal to close the H₂ flow control valve and close the O₂ flow control valve.

It is most preferred that the engine operate at a temperature between said warm temperature set-point and said hot temperature set-point. It is preferred that energy not leave the engine via engine coolant.

Materials of construction for the engine are to be those as known in the art for each application as said application is otherwise performed in the subject art. For example, various composite and metal alloys are known and used as materials for use at cryogenic temperatures. Various composite, ceramic and metal alloys are known and used as materials for use at operating temperatures of over 500° F. Various ceramic materials can be conductive, perform at operating temperatures of over 2,000° F., act as an insulator, act as a semiconductor and/or perform other functions. Various iron compositions and alloys are known for their performance in combustion engines that operate approximately in the 200 to 1,000° F. range. Titanium and tantalum alloys are known to operate over 2,000 and 3,000° F. Tantalum and tungsten are known to operate well over 3,000° F. It is preferred to have at least a portion of the construction of the engine contain an alloy composition wherein at least one of a period 4, period 5 and/or a period 6 heavy metal is used, as that metal(s) is known in the art to perform individually or to combine in an alloy or in a ceramic to limit corrosion and/or perform in a cryogenic temperature application and/or perform in a temperature application over 1,000° F. While aluminum is lightweight and can perform in limited structural applications, aluminum is temperature limited. Due to the operating temperatures involved in the instant invention, aluminum and thermoplastic materials are not preferred unless the application of use takes into account the glass transition temperature and the softening temperature of the thermoplastic material.

Certain objects are set forth above and made apparent from the foregoing description. However, since certain changes may be made in the above description without departing from the scope of the invention, it is intended that all matters contained in the foregoing description shall be interpreted as illustrative only of the principles of the invention and not in a limiting sense. With respect to the above description, it is to be realised that any descriptions, drawings and examples deemed readily apparent and obvious to one skilled in the art and all equivalent relationships to those described in the specification are intended to be encompassed by the present invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention, It is also to be understood that the following claims are intended to cover all of the generic and specific features of the invention herein described, and all statements of the scope of the invention, which, as a matter of language, might be said to fall in between.

I claim:

1. A method of fuel and oxidizer storage, wherein
at least one of the fuel and the oxidizer volatilize, wherein
rotating mechanical energy powers liquefaction, wherein
the rotating mechanical energy is created by at least one of:
an engine powered by the fuel and the oxidizer,
a fuel cell powered by the fuel and the oxidizer,
an electric motor powered by a fuel cell powered by the fuel and the oxidizer, and
an electric motor, wherein the electricity is created by PV or a PV Array, wherein
the volatiles from at least one of the fuel and the oxidizer have at least one flow through the liquefaction, wherein
the at least one flow is liquefied by the liquefaction, and wherein
heat rejection is performed from the flow by at least one of:
radiation, and
heat exchange with a heat rejection fluid.

2. The method of claim 1, wherein the storage is located in or on at least one of a: Space Ship, a Space Vessel, and Non-Earth Body.

3. The method of claim 1, wherein at least one of
said fuel comprises H₂, and
said oxidizer comprises O₂.

4. The method of claim 1, wherein at least one of
said heat rejection fluid comprises N₂, and
said heat rejection fluid comprises liquefaction.

5. The method of claim 1, further comprising at least one of:
at least one heat transfer fluid, and
at least one heat transfer fluid comprising N₂.

6. The method of claim 1, wherein said radiation or said heat exchange is performed within said flow downstream of a compressor or a Joule Thompson Effect.

7. The method of claim 1, wherein at least one of
said heat rejection fluid rejects heat by radiation, and
said heat rejection fluid rejects heat to at least one of a: Space Ship, Space Vessel and Non-Earth Body by conduction and the Space Ship, Space Vessel or Non-Earth Body rejects said heat by radiation.

8. The method of claim 1, wherein said liquefaction comprises at least one compressor for each flow and/or fluid.

9. The method of claim 1, wherein at least one of:
the engine is a turbine, and
the exhaust of said engine turns at least one steam turbine.

10. The method of claim 9, wherein the exhaust from said steam turbine(s) comprises a pressure of about 15 psia or less.

11. The method of claim 9, wherein said steam turbine(s) create said rotating mechanical energy.

12. The method of claim 9, wherein at least one of:
said engine and said steam turbine(s) comprise a common rotating shaft, and
said engine, said steam turbine(s) and at least one liquefaction compressor comprise a common rotating shaft.

13. The method of claim 1, further comprising at least one of:
a generator creating electricity, wherein
the generator is at least partially driven by said engine.

14. The method of claim 9, further comprising
a generator creating electricity, wherein
the generator is at least partially driven by said steam turbine(s).

15. The method of claim 13 or 14, wherein
said electricity created by said generator is at least a portion of said electricity.

16. The method of claim 9, further comprising at least one of:
insulating said engine, and
insulating said steam turbine(s).

17. The method of claim 9, further comprising
H₂O comprising at least one selected from a list consisting of a: corrosion inhibitor, chelant, dispersant, electrolyte and any combination therein.

18. The method of claim 9, wherein at least a portion of the exhaust of at least one of said engine and said steam turbine(s) is recycled to said engine or said steam turbine(s).

19. A Space Ship, comprising
a fuel storage tank, an oxidizer storage tank and a liquefaction unit, wherein
at least one of the fuel and the oxidizer volatilize, wherein
rotating mechanical energy powers the liquefaction unit, wherein
the rotating mechanical energy is created by at least one of:
an engine powered by the fuel and the oxidizer,
a fuel cell powered by the fuel and the oxidizer,
an electric motor powered by a fuel cell powered by the fuel and the oxidizer, and
an electric motor powered by PV or a PV Array; wherein
the volatiles from at least one of the fuel and the oxidizer have at least one flow through the liquefaction unit, wherein
the at least one flow is liquefied by the liquefaction unit, and wherein
heat rejection is performed from the flow by at least one of
a radiation unit comprising the flow, and
a heat exchanger comprising a heat rejection fluid.

20. The Space Ship of claim 19, wherein at least one of
said fuel comprises H₂, and
said oxidizer comprises O₂.

21. The Space Ship of claim 19, wherein at least one of
said heat rejection fluid is N₂, and
said heat rejection fluid management comprises liquefaction.

22. The Space Ship of claim 19, further comprising at least one of:
a heat transfer fluid, and
a heat transfer fluid comprising N₂.

23. The Space Ship of claim 19, wherein
said liquefaction comprises at least one compressor for each flow and/or fluid.

24. The Space Ship of claim 19, wherein at least one of
said heat rejection fluid rejects heat by radiation, and
said heat rejection fluid rejects heat to the Space Ship and the Space Ship rejects said heat by radiation.

25. The Space Ship of claim 19, wherein at least one of
said combustion engine is a turbine, and
the exhaust of said combustion engine turns at least one steam turbine.

26. The Space Ship of claim 25, wherein said engine and said steam turbine(s) comprise a common drive shaft.

27. The Space Ship of claim 21, further comprising at least one of:
a generator creating electricity, wherein the generator is at least partially driven by said engine, and
a generator creating electricity, wherein the generator is at least partially driven by said steam turbine(s).

28. The Space Ship of claim 28, wherein
at least a portion of said electricity created by said generator is at least a portion of said electricity.

29. The Space Ship of claim 25, further comprising at least one of:
insulating said engine, and
insulating at least one of said steam turbine(s).

30. The Space Ship of claim 19, wherein said radiation or said heat exchange is performed within said flow downstream of a compressor or a Joule Thompson Effect.

31. The Space Ship of claim 19, wherein
a device measures pressure in at least one of said storage tanks, wherein
the pressure measuring device sends a signal to a controller, and wherein
the controller determines at least one of:
rpm of at least one compressor in said liquefaction unit,
rpm of said engine, and then determines
amount of said fuel or of said oxidizer sent to said engine or to said fuel cell.
